(19) United States
(12) Patent Application Publication
(10) Pub. No.: US 2019/0251422 A1
(43) Pub. Date: Aug. 15, 2019

(54) DEEP NEURAL NETWORK ARCHITECTURE FOR SEARCH

(71) Applicant: Microsoft Technology Licensing, LLC, Redmond, WA (US)

(72) Inventors: Rohan Ramanath, Saratoga, CA (US); Gungor Polatkan, San Jose, CA (US); Liqin Xu, San Jose, CA (US); Bo Hu, Mountain View, CA (US); Shan Zhou, San Jose, CA (US); Harold Hotelling Lee, Alameda, CA (US)

(21) Appl. No.: 15/941,314

(22) Filed: Mar. 30, 2018

Related U.S. Application Data
(60) Provisional application No. 62/628,765, filed on Feb. 9, 2018.

(51) Int. Cl. G06N 3/04; G06F 17/30

(52) U.S. Cl. CPC G06N 3/0454; G06N 3/08; G06F 17/3053; G06N 3/04

(57) ABSTRACT

Techniques for implementing a deep neural network architecture for search are disclosed herein. In some embodiments, the deep neural network architecture comprises: an item neural network configured to, for each one of a plurality of items, generate an item vector representation based on item data of the one of the plurality of items; a query neural network configured to generate a query vector representation for a query based on the query, the query neural network being distinct from the item neural network; and a scoring neural network configured to, for each one of the plurality of items, generate a corresponding score for a pairing of the one of the plurality of items and the query based on the item vector representation of the one of the plurality of items and the query vector representation, the scoring neural network being distinct from the item neural network and the query neural network.

### CROSS-REFERENCE TO RELATED APPLICATIONS

This application claims priority to U.S. Provisional Application No. 62/628,765, filed on Feb. 9, 2018, and entitled, “Deploying deep models for search verticals,” which is hereby incorporated by reference in its entirety as if set forth herein.

### TECHNICAL FIELD

The present application relates generally to architectures for neural networks and, in one specific example, to methods and systems of implementing an architecture for neural networks used for search.

### BACKGROUND

Current architectures used for processing search queries suffer increased latency in processing search queries that involve complex considerations in generating search results for the search query. In these architectures, the more complex the data of the search query and the data of the items being evaluated for inclusion as search results, the more it is computationally expensive to process the search query while still providing relevant search results. As a result, current search architectures suffer from a technical problem of sacrificing processing speed for search result relevance or vice-versa. Other technical problems arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 illustrates components of an architecture of neural networks, in accordance with an example embodiment.

FIG. 4 illustrates additional aspects of the architecture of neural networks, in accordance with an example embodiment.

FIG. 5 illustrates a search infrastructure, in accordance with an example embodiment.

FIG. 6 illustrates a life cycle of a search query within a search infrastructure, in accordance with an example embodiment.

FIG. 7 is a flowchart illustrating a method of using a neural network architecture for search, in accordance with an example embodiment.

FIG. 8 is a block diagram illustrating a mobile device, in accordance with some example embodiments.

FIG. 9 is a block diagram of an example computer system on which methodologies described herein may be executed, in accordance with an example embodiment.

### DETAILED DESCRIPTION

Example methods and systems of implementing and using a neural network architecture for search are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to improve the ability of a search system to process search queries involving complex data, maximizing the relevance of the search results, while avoiding latency issues that hinder other search systems. Additionally, other technical effects will be apparent from this disclosure as well.

In some example embodiments, a system architecture comprises an item neural network, a query neural network, and a scoring neural network. The item neural network is configured to, for each one of a plurality of items stored on a database of an online service, retrieve item data of the one of the plurality of items from the database of the online service, and generate an item vector representation based on the retrieved item data of the one of the plurality of items. The query neural network is configured to generate a query vector representation for a query based on the query, the query being submitted by a computing device of the user of the online service and comprising at least one keyword, the query neural network being distinct from the item neural network. The scoring neural network is configured to, for each one of the plurality of items, generate a corresponding score for a pairing of the one of the plurality of items and the query based on the item vector representation of the one of the plurality of items and the query vector representation, the scoring neural network being distinct from the item neural network and the query neural network.

In some example embodiments, the item neural network, the query neural network, and the scoring neural network are implemented on separate physical computer systems, each one of the separate physical computer systems having its own set of one or more hardware processors separate from the other separate physical computer systems.

In some example embodiments, the item neural network, the query neural network, and the scoring neural network each comprise a deep neural network. In some example embodiments, the item neural network comprises a convolutional neural network.

In some example embodiments, the plurality of items comprises a plurality of documents. In some example embodiments, the plurality of items comprises a plurality of member profiles of a social networking service.

In some example embodiments, the system architecture comprises at least one module configured to rank the plurality of items based on their corresponding scores, and cause at least a portion of the plurality of items to be displayed on the computing device as search results for the query based on the ranking of the plurality of items.

The methods, operations, or embodiments disclosed herein may be implemented as one or more computer systems each having one or more modules (e.g., hardware modules or software modules). Such modules may be executed by one or more hardware processors of the computer system(s). The methods or embodiments disclosed herein may be embodied as instructions stored on a machine-readable medium that, when executed by one or more processors, cause the one or more processors to perform the instructions.

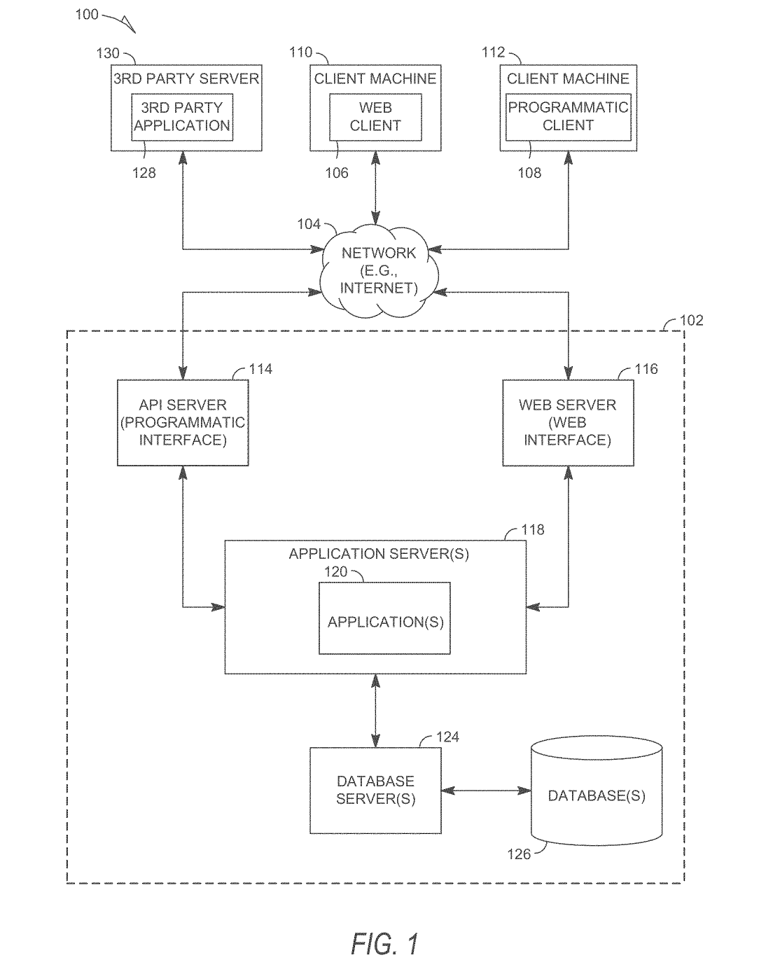

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

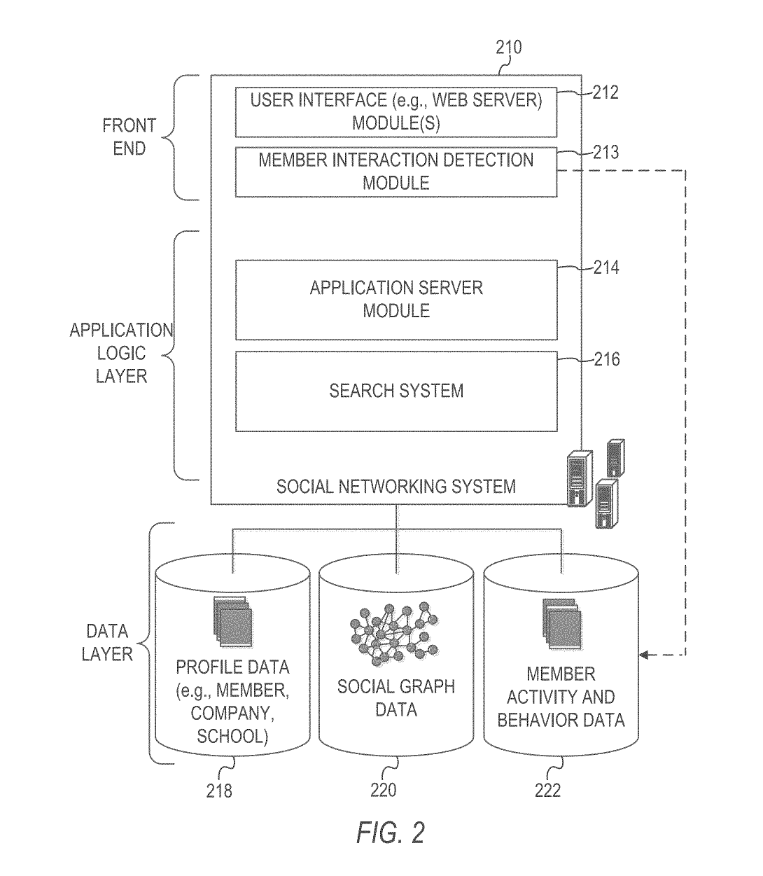

In some embodiments, the networked system 102 may comprise functional components of a social networking service. FIG. 2 is a block diagram showing the functional components of a social networking system 210, including a data processing module referred to herein as a search system 216, for use in social networking system 210, consistent with some embodiments of the present disclosure. In some embodiments, the search system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the search system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the search system 216 is referred to herein as being used in the context of a social networking service, it is contemplated that it may also be employed in the context of any website or online services, including, but not limited to a general purpose online search engine. Additionally, although features of the present disclosure can be used or presented in the context of a web page, it is contemplated that any user interface view (e.g., a user interface on a mobile device or on desktop software) is within the scope of the present disclosure.

In some example embodiments, the search system 216 provides innovative tools to help users (e.g., recruiters, hiring managers, and corporations) search for and acquire candidates for positions at an organization. One challenge in this process is in translating the criteria of a hiring position into a search query. The user performing the search has to understand which skills are typically required for a position, which companies are likely to have such candidates, and which schools the candidates are most likely to graduate from, as well as other detailed information. Moreover, the knowledge and information varies over time. As a result, often multiple attempts are required to formulate a good query. To help the user performing the search, the search system 216 may provide advanced targeting criteria called facets (e.g., skills, schools, companies, titles, etc.). The query can be entered by the user performing the search as free text, a facet selection (e.g., via selectable user interface elements corresponding to the facets) or the combination of the two. As a result, semantic interpretation and segmentation in such queries is important. For example, in the query “java” or “finance,” the user performing the search could be searching for a candidate whose title contains the word or someone who knows a skill represented by the word. Relying on exact term or attribute match in faceted search for ranking is sub-optimal. The search system 216 provides a solution to the matching and ranking problem rather than just focusing on the query formulation.

In some example embodiments, the search system 216 uses latent semantic models to map a noisy high dimensional query to a low-dimensional representation to make the matching problem tractable. In some example embodiments, the search system 216 extends latent semantic models with a deep structure by projecting queries and talent attributes into a shared low-dimensional space where the relevance of a talent given a query is readily computed as the distance between them. In some example embodiments, the search system 216 employs an architecture in which a neural network scoring a query-item pair is split into three semantic pieces, such that each piece is scored on a separate system with its own characteristics. Additionally, in some example embodiments, the search system 216 computes semantic similarity (used in a downstream learning to rank model) using online low-dimensional vector representations in a scalable way (being able to score millions of items, such as members of a social networking service) without compromising system performance or site stability.

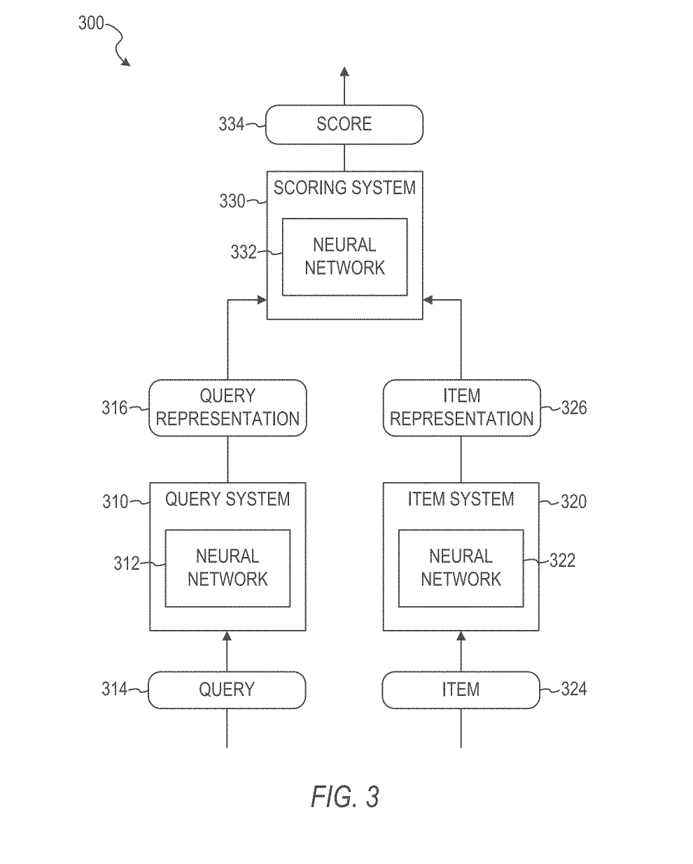

FIG. 3 illustrates components of an architecture 300 of neural networks, in accordance with an example embodiment. The architecture 300 may be implemented within the search system 216 of FIG. 2. In some example embodiments, the architecture 300 comprises a query system 310 comprising a query neural network 312, an item system 320 comprising an item neural network 320, and a scoring system 330 comprising a scoring neural network 332. In some example embodiments, the query neural network 312, the item neural network 322, and the scoring neural network 332 are implemented on separate physical computer systems 310, 320, and 330, respectively, with each one of the separate physical computer systems 310, 320, and 330 having its own set of one or more hardware processors separate and distinct from the other separate physical computer systems.

The query neural network 312 is configured to generate a query vector representation 316 for a query 314 based on the query 314. In some example embodiments, the query 314 is submitted by a computing device of a user of an online service and comprises at least one keyword entered by the user. In some example embodiments, the query 314 also comprises facet data, such as one or more facet selections.

The item neural network 322 is configured to, for each one of a plurality of items stored on a database of an online service, retrieve (or otherwise receive) item data 324 of the item from the database of the online service, and to generate an item vector representation 326 based on the retrieved item data 324 of the item. In some example embodiments, the plurality of items comprises a plurality of documents. For example, the plurality of items may comprise a plurality of documents searchable using a general purpose online search engine. In some example embodiments, the plurality of items comprises a plurality of member profiles of a social networking service, such as the member profiles stored in the database 218 in FIG. 2. However, other types of items are also within the scope of the present disclosure.

The scoring neural network 332 is configured to, for each one of the plurality of items, generate a corresponding score 334 for a pairing of the item and the query based on the item vector representation 326 of the item and the query vector representation 316. The scores 334 of the query-item pairings may then be used by the search system 216 to generate search results for the query 314, such as by ranking the items based on their scores 334, and then displaying at least a portion of the items based on their ranking.

In some example embodiments, the query neural network 312, the item neural network 322, and the scoring neural network 332 each comprise a deep neural network. In some example embodiments, the item neural network 322 comprises a convolutional neural network. However, it is contemplated that other types and configurations of the neural networks 312, 322, and 332 are also within the scope of the present disclosure.

The problem of certain searches, such as talent searches performed by recruiters, can be formulated as follows: given a query q by a recruiter r, rank a list of candidate members m₁, m₂, . . . , m_{d} in decreasingly relevant order by learning a function (e.g., a neural network scoring a query-member pair), f:q(r, mⱼ)→s_{i,j}∈ [symbol] In some example embodiments, the model is independent of the recruiter (r). In some example embodiments, the search system 216 uses pointwise models with a focus on learning a function that scores the similarity between the query and a member (or some other type of item). Using the architecture 300, the degree of model complexity of each module may be dictated by 1) implementation and serving constraints, and 2) requirements specified by a Service Level Agreement (SLA).

One drawback of the models used by other search systems is that they only consider text data. However, in some example embodiments of the search system 216, the query and member (or some other type of item) are represented by multiple sources of data (e.g., profile picture, education, job history, skills, and many more facets) and not just text. The problem of combining heterogeneous data of different modalities adds complexity to the ranking model. In some example embodiments, the search system 216 uses a late crossing variant of siamese networks to allow for computation of scores within strict SLAs to be served online.

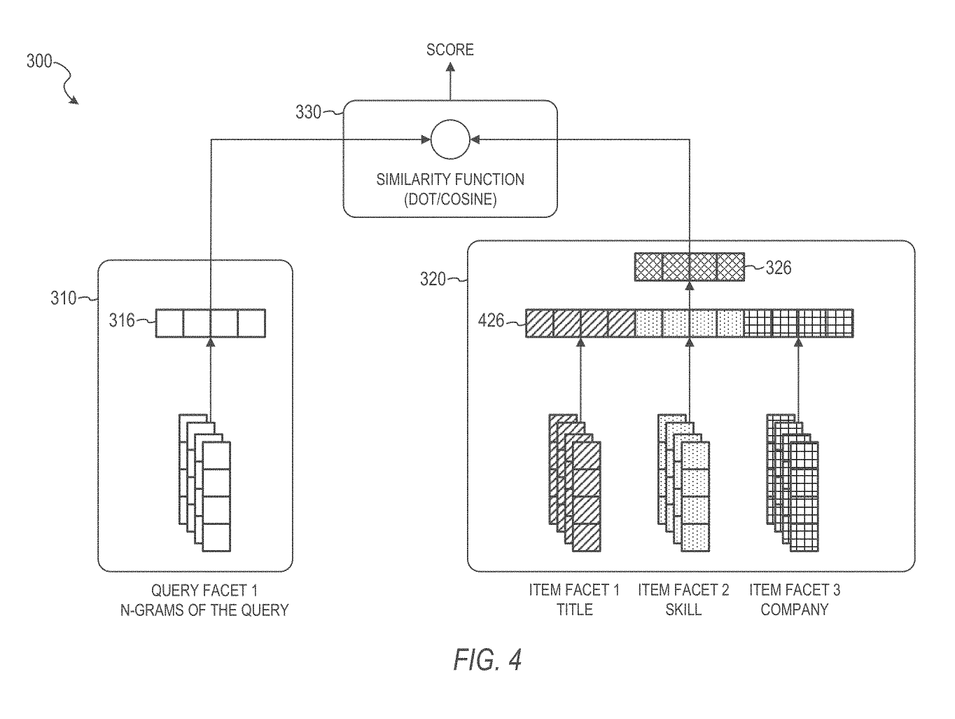

FIG. 4 illustrates additional aspects of the architecture 300 of neural networks, in accordance with an example embodiment. In the example embodiment of FIG. 4, the input to the architecture 300 is a combination of text and facet attributes. Each input layer of the neural networks of the query system 310 and the item system 320 converts the incoming attribute/text (n-gram) from a list of categorical features to a single embedding (e.g., via pooling) and an aggregation layer stacks embeddings from multiple attributes to one vector representation. In some example embodiments, the vector representation 426 of each attribute is concatenated into a single vector representation 326 of the item. Since the item (e.g., member) arm has a richer source of input data, there is more opportunity to learn representative structures. This intuition manifests itself via a deeper and structurally richer (i.e., convolutions) item arm that eventually produces the item representation 326. The shorter query arm of the query system 310 leverages query text and facets selected by the user in the search user interface to produce the query representation 316. The similarity layer of the scoring system 330 (e.g., using a fully-connected, cosine, or any distance function) processes the query representation 316 and the item representation 326 to produce a score 324 that captures semantic similarity between the two representations 316 and 326.

In some example embodiments, the architecture 300 is employed by the search system 216 and enables the search system 216 to assign a globally unique identifier (UID) for each item (e.g., each document), for example, a member identification for each member profile, as well as to search over both offline indexes and real-time updates at the same time, and plug in any relevance functions and algorithms, freeing them from using a fixed scoring framework. Users can design their own relevance functions on a rich set of information about search hits, including term frequency, document frequency, matched terms, and any metadata associated with a search hit document.

In some example embodiments, relevance modules can be plugged into the architecture 300 of the search system 216 to gather raw results from a search, and implement sorting or custom result filtering, collation, and so on. In some example embodiments, the search system 216 may collect the raw search results, collect the forward index, and provide a pluggable scoring mechanism, which users can use as a data provider that offers the information of a search hit, document info (e.g., from the forward index) or any other custom information (e.g., from the forward index), and apply any relevance functions on the data.

In some example embodiments, the scoring system 330 computes the similarity sim(q, m) between a query q that contains terms {t₁, t₂, . . . } and member m that has attributes {a₁, a₂, . . . }. The terms and member attributes may be keywords, tokens, or attributes of a user profile, such as skills, titles, or company/school the user identifies with. In some example embodiments, the search system 216 uses latent representations to compute similarity sim(q, m). The search system 216 may learn representations for different types of entities. For example, the search system 216 may use the representation of the entire query and the entire member profile. The search system 216 may alternatively use a representation of an individual query term and member attribute.

In some example embodiment, the search system 216 uses token level embeddings, using the embedding vectors (e.g., latent representations) of query terms (e.g., tokens) ({t₁, t₂, . . . } and member attributes (e.g., tokens) {a₁, a₂, . . . } to compute the query-member similarity. The token embeddings may be used to compute sim(q, m) in one of the following ways.

In the first way, the search system 216 aggregates the similarity between individual query terms and member attributes sim(tᵢ, aₖ). Each similarity score can be added as a feature to a linear model. The advantages of such as model are: (1) Easy path to productionization, such as by using an off-heap dictionary (or key-value store) containing the token embeddings in the online service; and (2) No loss of information for tail queries or rare documents, since the information stored is at the token level. However, some disadvantages of this approach are that: (1) The dictionary size has limitation because it is challenging to store more than a couple of hundreds of MB; and (2) If the query contains a lot of terms, and the member has a lot of attributes, then computing similarities can be pretty time-consuming.

In the second way, the search system 216 uses a nonlinear function such as neural networks to get a query-member similarity using the token level embeddings as features. The advantage of using nonlinearity is the richer set of interaction features that can be extracted from the raw data. However, as one stacks on layers in the network, the latency to score the function gets expensive. The additional cost comes from the fact that, for each query, thousands of members need to be scored at run-time. In some example embodiments, the search system 216 uses this approach in a downstream (e.g., broker) re-ranker that has significantly fewer query-member pairs as compared to the primary ranker in the search nodes.

In some example embodiments, the search system 216 uses document Level embeddings, retrieving the representation (e.g., embedding) for the entire query and the member (e.g., document or other type of item). This solution is particularly useful when the query distribution has a long tail, such as when the head queries serve a significant portion of the online search traffic. In such a situation, the search system 216 can learn a complex function to represent the query and the member, and store the resulting query and member representations in key-value stores. In some example embodiments, the search system 216 alternatively uses an external key-value store to persist the member representation in order to provide a workaround for other search verticals and address the issue of space limitations and latency issues for storing such dense real-valued vectors in a forward index.

However, the design of some search systems restricts the search nodes from making external service calls. In some example embodiments, the search system 216 uses a hybrid approach. Since the query distribution for certain types of search (e.g., recruiter searches) does not have a long tail, in some example embodiments, the search system 216 does not use the document level embedding to pre-compute the query representation. Additionally, since the number of members that need to be scored for each query is may be of the order of a hundred thousand or greater, in some example embodiments, the search system 216 does not use token level representation for the member side because the memory and latency considerations are restrictive. In some example embodiments, the search system 216 uses a hybrid approach using token level embeddings for one of the two sides and document level embeddings for the other side.

In some example embodiments, the architecture 300 of the search system 216 employs a design principle of dividing and conquering. The architecture 300 may comprise three main parts while serving a query-member pair: (1) Offline distributed processing to process offline data and lower the load on the online system in document processing and index preparation; (2) Online query processing for receiving the search request and performing an early evaluation and processing of the query; and (3) Searchers—the distributed platform carrying the index and performing the search based on the processed query and previously prepared offline data. In some example embodiments, the search system 216 employs a modularization of this design principle, semantically splitting the architecture 300 so that offline processing corresponds to the item (e.g., member) neural network 322 of the item system 320, online processing corresponds to the query neural network 312 of the query system 310, and searchers correspond to the cross network of the scoring system 330. This implementation makes use of this pairing for executing and scoring of each piece of the model.

In some example embodiments, the offline distributed component is used mostly for item neural network 322 processing. Since the member profiles (e.g., member data, such as education, job history, skills, and many more facets) are known offline, the item neural network 322 may pre-compute the member representation, compress and store this resultant vector in the forward index of the searcher. The search system 216 can tolerate infrequent updates to the member representation because the member profile information is relatively static.

In some example embodiments, the search system 216 is responsible for processing each search request of an online service, and may employ a Representation State Transfer (REST) service. The query may be evaluated and processed on the fly to extract query features like trigrams of text and search facets, such as skill, title, company, and the like. The query neural network 312 may use this as the input to produce a query representation as the output. Since the module may be scored at real time and may have tight SLAs, the network complexity may be limited by the time to score. In one example, let us assume that we just have one attribute, such as title (t) on both the query and member side. Everything that follows can be extended to any number and types of attributes. A key-value store may be used to store attribute, facet vectors, such as one vector for every title tᵢ (or one vector for every n-gram, if we consider n-grams of the raw text as the query feature). The search frontend may parse the query (the tagged textual query and selected facet) to determine all the titles targeted by the viewer. The vectors corresponding to all the targeted titles may be retrieved and the query arm of the network may be evaluated in the search frontend. The resultant query representation may then be inserted into the query metadata in the call to the search backend. Although evaluating the query arm can be computationally expensive (depending on the depth), in some example embodiments, this happens only once for a search request unlike the member arm of the network. In some example embodiments, an alternate solution involves pre-computing and storing the query representation for the head queries, and then directly retrieving them.

In some example embodiments, the architecture 300 of the search system 216 provides a search-as-a-service infrastructure for a cross network as the final scoring, such as for the scoring system 330. The offline generated member representation and REST service generated query representation may be unified on the search nodes where the final piece of the scorer is evaluated.

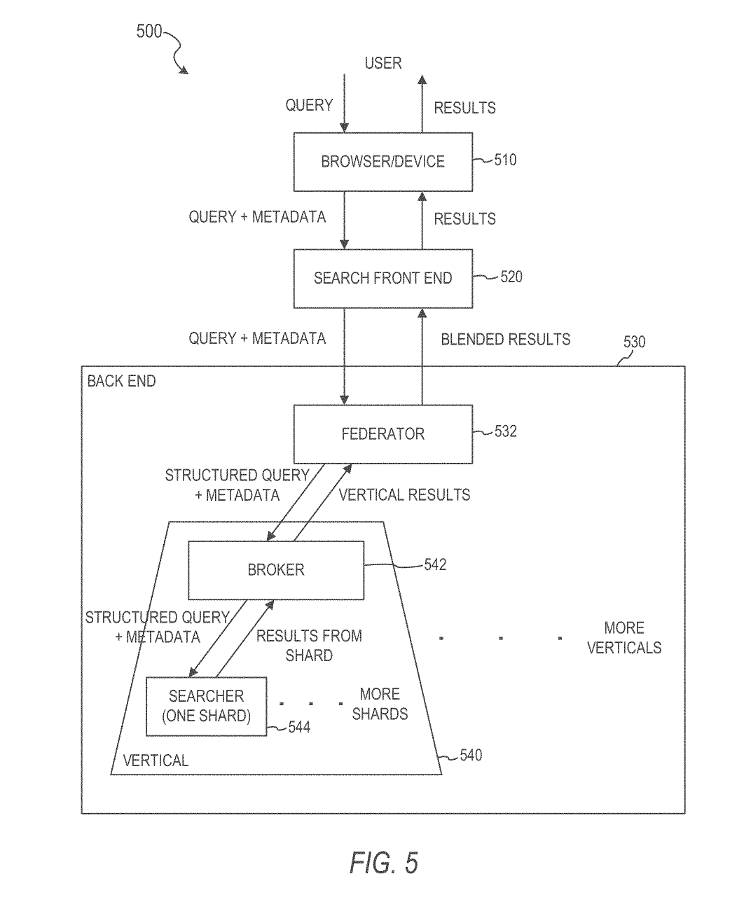

FIG. 5 illustrates a search infrastructure 500 using the architecture 300, in accordance with an example embodiment. In FIG. 5, the query starts at the browser/device 510, where some processing may take place in receiving the query from the user. The query then moves on to the web front end 520, where further processing may take place. The query may then proceed to the back end 530, where the bulk of the search functionality resides. The results returning from the back end 530 are transmitted back to the user through the front end 520 to the browser/device 510.

In some example embodiments, the back end 530 comprises a federator 532 and multiple brokers 542. The federator 532 and the broker(s) 542 may both accept a query along with metadata, and fan it out to multiple services, then wait for responses from these services, combine these responses, and return them back to the caller. As the query works its way down, the federator 532 may invoke a query rewriter to rewrite the query it receives into a structured retrieval query. The query rewriter may also enhance the query with additional metadata. The federator 532 may then pass its output to one or more search verticals 540. Each search vertical 540 may serve a specific kind of entity—for example, members, companies, or jobs.

In some example embodiments, the receiving service in each vertical 540 is the broker 542. The broker 542 may perform additional vertical specific query rewriting before passing its output to the searchers 544. The broker 542 may wait for the searchers 544 to return results, and then merge them together. This merging process may comprise a merge sort based on a score, or could be a re-ranker that performs more sophisticated merging.

In some example embodiments, the merged results are sent to the federator 532, which in turn combines (or blends) the results from multiple verticals 540. The blending process can involve some complex relevance algorithms. The federator 532 may then return the blended results to the front end 520.

The federator 532 and the broker 542 may both be instantiations of the same system, which offers the ability to plug in rewriters and mergers. Query rewriters may be built as plug-ins to a rewriter API exported by the federator 532 and/or the broker 542. The job of the query rewriter is to take the raw query and user metadata, and convert it into a structured retrieval query. In addition, the metadata may be enriched as necessary to help with the relevance measurement processes in subsequent stages.

In some example embodiments, each searcher 544 operates on a single shard of the index (e.g., the forward index). Each searcher 544 may receive the rewritten query and metadata from the broker 544, and retrieve matching entities from the index. The entities may then be scored and the top scoring entities may be returned to the broker 542. In some example embodiments, the scorer uses the input query, the input metadata, details on how the query matched the entity, and the forward index to determine the importance of the entity as a result for the query.

In some example embodiments, the back end 530 (e.g., the federator 532, the broker 542, and the searcher(s) 544) is self-sufficient and is not allowed to make external service calls. This design allows for the search back end 530 to be run against a suite of integration tests that evaluate the quality of the search index and ranking models before deployment. A side effect of this design is that it can prevent one from using an external key-value store to store the pre-computed member representation. At request time, once the members have been retrieved for the query q, each member's representation (e.g., via the forward index) along with the query representation (e.g., via the request to the back end) may be evaluated via the similarity layer in the searcher 544 to produce a score for every query-member pair, which may then be used as a feature in the ranking model.

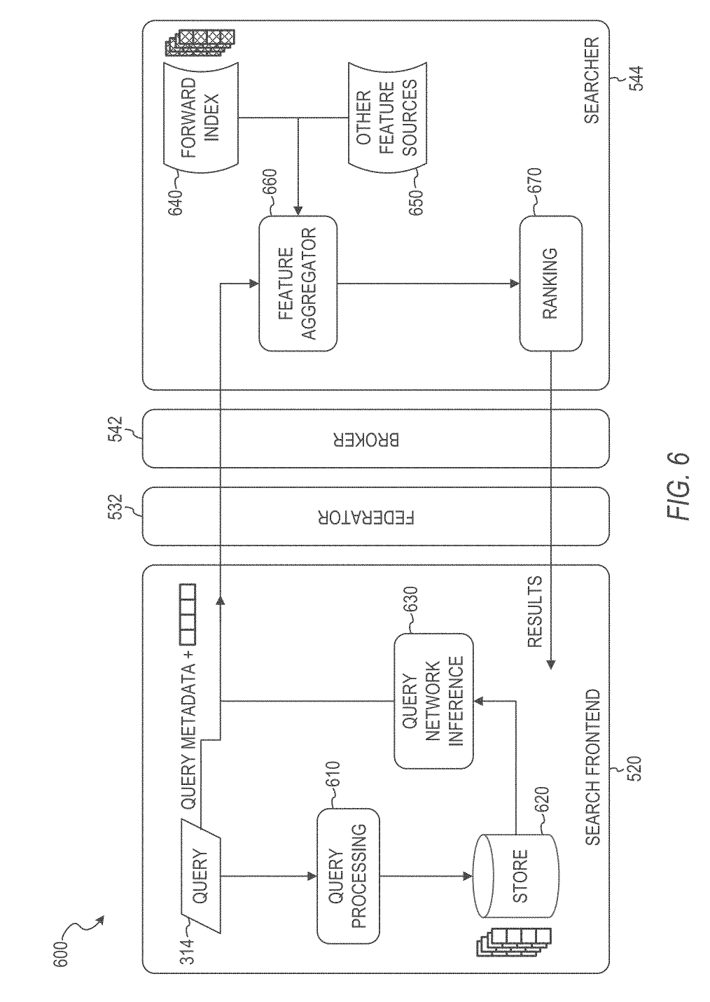

FIG. 6 illustrates a life cycle of a search query within a search infrastructure 600, in accordance with an example embodiment. At runtime, the query 314 is input into the search system 216, and a query processing unit 610 performs one or more processing operations, such as query expansion, extracting features, extracting facets, and creating input for the query neural network 310. For some of the facets, vector representations of them have been generated offline and stored on a key-value store 620. The search system 216 may retrieve the vector representation(s) for the processed query, using the vector representation(s) stored on the key-value store 620.

In some example embodiments, the query network inference unit 630 takes the raw query 314 as input, as well as the learned vector representation(s) from the key-value store 620, and runs them through the query neural network 310 to produce a query vector representation. This query vector representation is then transmitted to the federator 532, which splits up the request, transmitting it to multiple brokers 542, with each broker splitting the request up to be transmitted to multiple searchers 544. Each searcher 544 has some of its item vector representations (e.g., member vector representations) stored on its forward index 640. All of the searchers 544 may be performing the same operations in parallel, only on a different set of items (e.g., a different set of members). Each searcher 544 may run the query representation and the item representation (e.g., member representation), along with other feature data of the item from other feature sources 650, through a feature aggregator 660, which may feed them as inputs into the scoring neural network 332, generating a similarity score for every query-item pair (e.g., every query-member pair). The searcher 544 may employ a ranking unit 670 to rank all of the items (e.g., members) based on their similarity scores. The searchers 544 may then return their results to their broker 542. The broker 542 aggregates the results across different searchers 544, and returns the results (or a portion thereof) to the federator 532, which returns a certain portion of the results (e.g., the top scoring results) to the search front end 520 for display in response to the query 314.

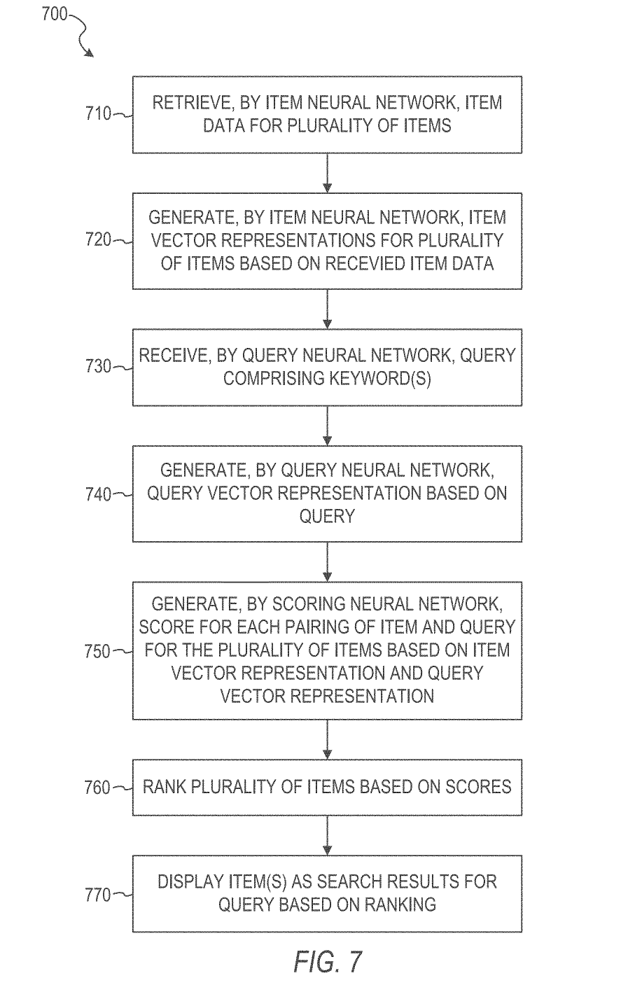

FIG. 7 is a flowchart illustrating a method 700 of using a neural network architecture for search, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the search system 216 of FIG. 2 or any of the architectures or infrastructures of FIGS. 3-6, or any combination thereof.

At operation 710, the item neural network 322, for each one of a plurality of items stored on a database of an online service, retrieves item data of the one of the plurality of items from the database of the online service. At operation 720, the item neural network 322, for each one of the plurality of items, generates an item vector representation based on the retrieved item data of the one of the plurality of items. At operation 730, the query neural network 312 receives a query from a computing device of the user of the online service, the query comprising at least one keyword. At operation 740, the query neural network 312 generates a query vector representation for the query based on the at least one keyword, the query neural network being distinct from the item neural network. At operation 750, the scoring neural network 332, for each one of the plurality of items, generates a corresponding score for a pairing of the one of the plurality of items and the query based on the item vector representation of the one of the plurality of items and the query vector representation. At operation 760, at least one module of the search system 216 ranks the plurality of items based on their corresponding scores. At operation 770, at least one module of the search system 216 causes at least a portion of the plurality of items to be displayed on the computing device as search results for the query based on the ranking of the plurality of items.

It is contemplated that any of the other features described within the present disclosure can be incorporated into the method 700.

Example Mobile Device

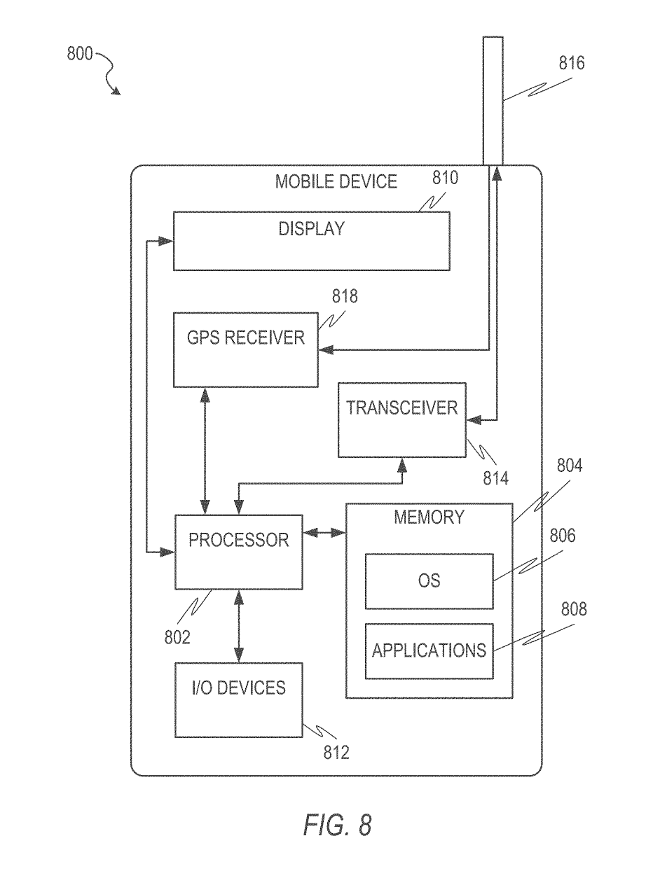

FIG. 8 is a block diagram illustrating a mobile device 800, according to an example embodiment. The mobile device 800 can include a processor 802. The processor 802 can be any of a variety of different types of commercially available processors suitable for mobile devices 800 (for example, an XScale architecture microprocessor, a Microprocessor without Interlocked Pipeline Stages (MIPS) architecture processor, or another type of processor). A memory 804, such as a random access memory (RAM), a Flash memory, or other type of memory, is typically accessible to the processor 802. The memory 804 can be adapted to store an operating system (OS) 806, as well as application programs 808, such as a mobile location-enabled application that can provide location-based services (LBSs) to a user. The processor 802 can be coupled, either directly or via appropriate intermediary hardware, to a display 810 and to one or more input/output (I/O) devices 812, such as a keypad, a touch panel sensor, a microphone, and the like. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example Machine Architecture and Machine-Readable Medium

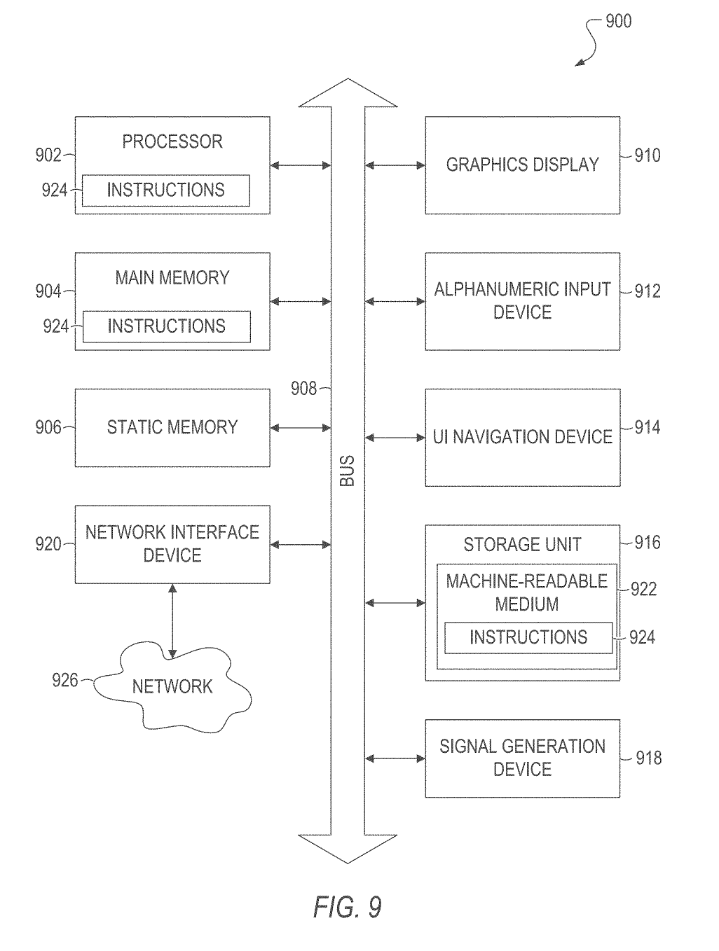

FIG. 9 is a block diagram of an example computer system 900 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a graphics display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a storage unit 916, a signal generation device 918 (e.g., a speaker) and a network interface device 920.

Machine-Readable Medium

The storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions (e.g., instructions 924) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Transmission Medium

The instructions 924 may further be transmitted or received over a communications network 926 using a transmission medium. The instructions 924 may be transmitted using the network interface device 920 and any one of a number of well-known transfer protocols (e.g., HITP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
an item neural network configured to, for each one of a plurality of items stored on a database of an online service, retrieve item data of the one of the plurality of items from the database of the online service, and generate an item vector representation based on the retrieved item data of the one of the plurality of items;
a query neural network configured to generate a query vector representation for a query based on the query, the query being submitted by a computing device of the user of the online service and comprising at least one keyword, the query neural network being distinct from the item neural network; and
a scoring neural network configured to, for each one of the plurality of items, generate a corresponding score for a pairing of the one of the plurality of items and the query based on the item vector representation of the one of the plurality of items and the query vector representation, the scoring neural network being distinct from the item neural network and the query neural network.

2. The system of claim 1, wherein the item neural network, the query neural network, and the scoring neural network are implemented on separate physical computer systems, each one of the separate physical computer systems having its own set of one or more hardware processors separate from the other separate physical computer systems.

3. The system of claim 1, wherein the item neural network, the query neural network, and the scoring neural network each comprise a deep neural network.

4. The system of claim 3, wherein the item neural network comprises a convolutional neural network.

5. The system of claim 1, wherein the plurality of items comprises a plurality of documents.

6. The system of claim 1, wherein the plurality of items comprises a plurality of member profiles of a social networking service.

7. The system of claim 1, further comprising at least one module configured to:
rank the plurality of items based on their corresponding scores; and
cause at least a portion of the plurality of items to be displayed on the computing device as search results for the query based on the ranking of the plurality of items.

8. A computer-implemented method comprising:
for each one of a plurality of items stored on a database of an online service, retrieving, by an item neural network, item data of the one of the plurality of items from the database of the online service;
for each one of the plurality of items, generating, by the item neural network, an item vector representation based on the retrieved item data of the one of the plurality of items;
receiving, by a query neural network, a query from a computing device of the user of the online service, the query comprising at least one keyword;
generating, by a query neural network, a query vector representation for the query based on the at least one keyword, the query neural network being distinct from the item neural network; and
for each one of the plurality of items, generating, by a scoring neural network, a corresponding score for a pairing of the one of the plurality of items and the query based on the item vector representation of the one of the plurality of items and the query vector representation, the scoring neural network being distinct from the item neural network and the query neural network.

9. The computer-implemented method of claim 8, wherein the item neural network, the query neural network, and the scoring neural network are implemented on separate physical computer systems, each one of the separate physical computer systems having its own set of one or more hardware processors separate from the other separate physical computer systems.

10. The computer-implemented method of claim 8, wherein the item neural network, the query neural network, and the scoring neural network each comprise a deep neural network.

11. The computer-implemented method of claim 10, wherein the item neural network comprises a convolutional neural network.

12. The computer-implemented method of claim 8, wherein the plurality of items comprises a plurality of documents.

13. The computer-implemented method of claim 8, wherein the plurality of items comprises a plurality of member profiles of a social networking service.

14. The computer-implemented method of claim 8, further comprising:
ranking the plurality of items based on their corresponding scores; and
causing at least a portion of the plurality of items to be displayed on the computing device as search results for the query based on the ranking of the plurality of items.

15. A non-transitory machine-readable medium embodying a set of instructions that, when executed by at least one hardware processor, cause the processor to perform operations, the operations comprising:
for each one of a plurality of items stored on a database of an online service, receiving, by an item neural network, item data of the one of the plurality of items from the database of the online service;
for each one of the plurality of items, generating, by the item neural network, an item vector representation based on the received item data of the one of the plurality of items;
receiving, by a query neural network, a query from a computing device of the user of the online service, the query comprising at least one keyword;
generating, by a query neural network, a query vector representation for the query based on the at least one keyword, the query neural network being distinct from the item neural network; and
for each one of the plurality of items, generating, by a scoring neural network, a corresponding score for a pairing of the one of the plurality of items and the query based on the item vector representation of the one of the plurality of items and the query vector representation, the scoring neural network being distinct from the item neural network and the query neural network.

16. The non-transitory machine-readable medium of claim 15, wherein the item neural network, the query neural network, and the scoring neural network are implemented on separate physical computer systems, each one of the separate physical computer systems having its own set of one or more hardware processors separate from the other separate physical computer systems.

17. The non-transitory machine-readable medium of claim 15, wherein the item neural network, the query neural network, and the scoring neural network each comprise a deep neural network.

18. The non-transitory machine-readable medium of claim 17, wherein the item neural network comprises a convolutional neural network.

19. The non-transitory machine-readable medium of claim 15, wherein the plurality of items comprises a plurality of documents.

20. The non-transitory machine-readable medium of claim 15, wherein the plurality of items comprises a plurality of member profiles of a social networking service.
